(19) United States
(12) Patent Application Publication
(10) Pub. No.: US 2009/0254030 A1
(43) Pub. Date: Oct. 8, 2009

(54) Oral Medication Bottle with Detachable Oral Syringe

(76) Inventor: Natalie Levy Sarraf, Santa Monica, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 12/099,770

(22) Filed: Apr. 8, 2008

(51) Int. Cl. A61J 7/00; A61J 1/14

(52) U.S. Cl. 604/77; 220/735

(57) ABSTRACT

A bottle for dispensing oral medication has a concavity in its side wall for partially receiving the cylindrical cross section of an oral medication syringe, and also has a syringe holder integrally formed with the bottle for retaining the syringe in the concavity, thereby to keep the syringe assembled to the bottle and readily available for dispensing the medication in the bottle. The concavity and the syringe holder may take different forms, including clip arms and holder sleeves integral with the bottle. The bottle and syringe make a compact assembly for convenient packaging, storage and handling.

### BACKGROUND OF THE INVENTION

1. Field of the Invention

This invention relates to containers for liquids provided with detachable syringes for dispensing the liquid contents, and more particularly is concerned with medication bottles provided with detachable oral syringes for administering doses of oral medications.

2. State of the Prior Art

Many medications are administered orally in liquid form and are dispensed to patients in bottles, typically glass or plastic bottles with a screw-on cap. Such medications are often prescribed to young children and infants. Conventionally the liquid oral medication was then administered to the young patient by pouring out a dose onto a spoon and feeding the dose to the patient. In practice it has been found that the dose actually administered can vary substantially as different size spoons are used and are filled to varying levels. In some cases overdoses can be administered when relatively large spoons are used to medicate infants. This difficulty has led to common use of oral syringes for the administration of oral medications instead of spoons. The oral syringe has a syringe barrel with graduated markings which allow accurate and consistent dosing of the medication. Usually the syringe barrel has a pair of finger flanges which extend in diametrically opposed directions from the top end of the syringe barrel. Oral syringes are generally similar to conventional injection syringes except that the nozzle of the oral syringe is sized and shaped in a way which prevents attachment of a hypodermic needle to the syringe, and the nozzle is blunt ended to prevent injury when the end of the syringe is placed in the mouth of a patient, particularly the mouth of a small child. By pushing on the plunger of the syringe the liquid medication is squirted from the syringe barrel through the syringe nozzle into the patient's mount.

Presently oral medication bottles and the oral syringe for dispensing the medication are sold as separate items and can easily become lost from each other by the end user. There is no convenient means for keeping the syringe together with the medication bottle to ensure that the syringe is available when needed, and users often revert to using a spoon because the syringe is not at hand.

This issue has been previously addressed in patents Nos. Des. 363,211 and U.S. Pat. No. 6,565,054 where medication bottles have been provided with metal clips for the purpose of attaching a dispensing syringe to the bottle. These past efforts fall short of an optimal solution to the problem, however. For one thing, a separate clip must be fabricated and provided with the bottle. Also, the clip method of attachement results in a relatively bulky side-by-side assembly of bottle and syringe which is not conducive to efficient packaging, handling and use.

What is needed is a more efficient, compact and economical approach to retaining an oral syringe to a bottle of liquid oral medication.

### SUMMARY OF THE INVENTION

This invention addresses these and other shortcomings of the prior art and provides a bottle adapted for compact and reliable assembly with an oral syringe of the type having a barrel with a plunger slidable in one end of the barrel for displacing fluid through an orificed syringe nozzle on an opposite end of the barrel.

The bottle according to this invention has a bottle wall, a bottle shoulder, a bottle neck defining a bottle mouth and a bottle bottom. The bottle has a syringe holder which includes a holder recess and a syringe retainer. The syringe holder keeps the syringe in assembled relationship to the bottle. The syringe is removable from the syringe holder, in one embodiment by pulling the syringe radially away from the bottle, in another embodiment by lifting the syringe from the holder.

A holder recess is formed in the bottle wall between the shoulder and the bottom of the bottle, shaped for at least partially receiving the transverse cross section of the syringe. The bottle also has a syringe retainer which is integral with the bottle wall, as by being molded in one piece with the bottle, for releasably retaining the syringe in the aforementioned recess.

In one form of the invention the holder recess is defined by a pair of flat surfaces intersecting along a corner line in the recess, such that the recess has a pie-slice shaped cross section. The flat surfaces and the corner line may extend from the shoulder to the bottom of the bottle. In another form of the invention the recess has a cylindrically curved interior surface and may also extend from the shoulder to the bottom of the bottle.

The syringe retainer can take the form of opposing retainer arms formed integrally with the bottle wall for capturing therebetween and releaseably retaining the syringe, for example, when the syringe barrel is pressed between the retainer arms. In an alternate form of the invention the syringe retainer is in the form of an arcuate retainer sleeve integrally formed with the bottle wall and spanning the recess for encompassing the barrel of the syringe, such that the cross section of the syringe barrel is contained partly in the recess and partly encompassed by the retainer sleeve when the syringe is inserted into an open end of the syringe holder defined in part by the holder recess and in part by the syringe retainer.

A syringe support may be provided for supporting the syringe nozzle above and away from contact with the surface under the bottle. In one embodiment the syringe support is a rest plate integral with the bottle wall at or near the lower end of the holder recess for supporting the nozzle of the syringe. Alternatively, the syringe support is a top edge of the retainer sleeve located for supporting the finger flanges at the plunger end of the syringe barrel, thereby supporting the syringe at a given height relative to the bottle and away from contact with an underlying surface.

The just described alternate forms of the holder recess, the syringe retainer and the syringe support may be provided in different combinations in particular bottles.

These and other improvements, features and advantages of the present invention will be better understood by reference to the following detailed description of the preferred embodiments taken in conjunction with the accompanying drawings.

### BRIEF DESCRIPTION OF THE DRAWINGS

FIG. 1 is a perspective view of a first embodiment of an oral medication bottle according to this invention shown with a typical oral syringe;

FIG. 2 is a perspective view of the oral syringe assembled to the medication bottle of FIG. 1;

FIG. 3 is a side elevational view of the assembled bottle and syringe of FIG. 2;

FIG. 4 is a cross-sectional view taken along line 4-4 in FIG. 3;

FIG. 5 is a perspective view of a second embodiment of the oral medication bottle provided with a syringe rest in the form of a base plate near the bottom of the holder recess;

FIG. 6 is a perspective view of a third embodiment of the oral medication bottle provided with a retainer sleeve spanning the holder recess for encompassing the syringe and also having a syringe rest base plate near the bottom of the holder recess;

FIG. 7 is a perspective view of a fourth embodiment of the oral medication bottle wherein the holder recess has a cylindrically curved inner surface, and the holder sleeve has a top edge located near the shoulder of the bottle for supporting the syringe in lieu of a base plate at the bottom of the holder recess;

FIG. 8 illustrates a fifth embodiment of the oral medication bottle wherein the cylindrically curved inner surface of the holder recess encompasses more than 180 degrees of the syringe barrel circumference thereby retaining the syringe against radial separation from the bottle without the holder arms or sleeve of the previous embodiments, and wherein the bottle shoulder supports the syringe against dropping into or through the holder recess to the bottom of the bottle; and

FIG. 9 is a cross-sectional view taken along line 9-9 in FIG. 8.

### DETAILED DESCRIPTION OF THE PREFERRED EMBODIMENTS

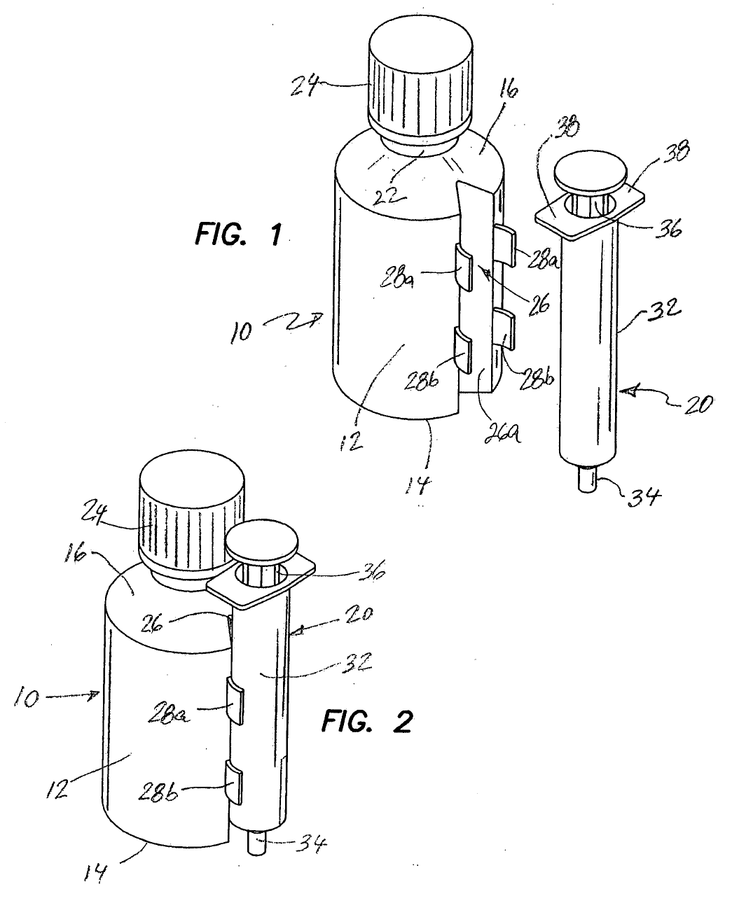

With reference to the accompanying drawings in which like elements are designated by like numerals, FIG. 1 shows an oral medicine bottle generally designated by numeral 10 and an oral syringe 20.

The syringe 20 may be a conventional oral type syringe having a cylindrical syringe barrel 32 with an orificed nozzle 34 at one end and a plunger 36 at a second opposite end. A pair of finger phalanges 38 extend outwardly or radially from the barrel 32 at the plunger end of barrel 32. The plunger 36 carries a piston inside the barrel 32 such that movement of the plunger 36 pushes or pulls the piston in the barrel 32 for displacing liquid through the orificed nozzle 34, in a well known manner.

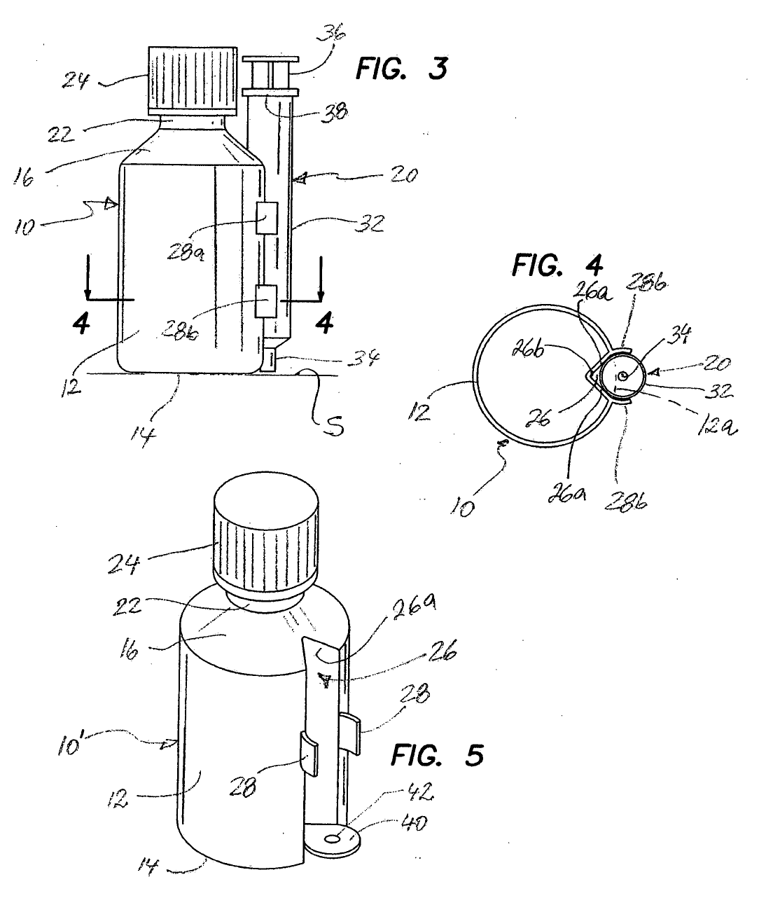

The bottle 10 has a bottle wall 12, a bottle bottom 14, a bottle shoulder 16, and a bottle neck which defines a bottle mouth closed by a bottle cap 24. The bottle wall 12 is cylindrical between the bottle shoulder 16 and bottle bottom 14 but is circumferentially interrupted by a syringe holder recess or concavity 26 which is sized and shaped for receiving at least part of the transverse cross-section of syringe 20, as best understood by reference to the cross-sectional view of FIG. 4. The recess 26 is defined by two planar interior surfaces 26a intersecting along a corner line 26b, and in cross section has a pie-slice shape. Recess 26 extends vertically between top and bottom ends on shoulder 16 and bottom 14, respectively, of bottle 10, and the recess 26 is open at both these ends.

The bottle 10 also has a syringe retainer which in the embodiment of FIGS. 1 and 2 takes the form of two opposing pairs of retainer arms 28a,b which are formed, as by molding, integrally with the bottle wall 12 of bottle 10 on either side of the holder recess 26. The retainer arms 28a,b are rectangular plates concavely shaped on their mutually facing surfaces so as to generally conform to the curved outer surface of the syringe barrel 32. The spacing of the opposing retainer arms is such that each arm pair is forced apart slightly when the syringe barrel 32 is pressed between the arms and into recess 26. The bottle 10 including retainer arms 28 are made of a relatively stiff but resiliently yielding material such as an elastomer chosen to allow the retainer arms 28 to flex a relatively small distance while maintaining an elastic return force against the syringe barrel, so as to hold the syringe 20 in recess 26 against bottle 10, as illustrated in the assembly of FIG. 2. The syringe 20 is releasable from bottle 10 by manual pulling force away from the bottle sufficient to overcome the gripping force of the retainer arms 28. The tension of arms 28 against syringe barrel 32 also holds the syringe at a particular elevation relative to bottle 10, that is, prevents the syringe from sliding downwardly along the bottle towards the bottom 14 and keeps the nozzle 34 from touching the underlying surface S which supports the bottle bottom, as seen in FIG. 3.

FIG. 4 shows how part of the syringe barrel cross-section is admitted into the holder recess 26 of bottle 10 to reduce the overall profile of the bottle-syringe assembly of FIG. 3. Specifically, nearly one-half of the outside diameter of the syringe barrel 32 is admitted within the circular perimeter of the bottle wall 12 suggested by the dotted line 12a across the recess 26 in the embodiment of FIGS. 1-4. The result is a relatively compact assembly for convenient packaging and storage. Also, the syringe 20 is relatively protected against accidental dislodgement at an end user location by virtue of being partially included within the perimeter of the bottle wall, thereby further ensuring that the syringe remains available and close at hand during a course of medication which may extend over a period of weeks until the prescribed course of medication or the contents of the bottle are exhausted, whichever comes first.

FIG. 5 shows a second embodiment of the oral medical bottle 10′ according to this invention which differs from the embodiment of FIG. 1 in that only a single pair of opposing retainer arms 28 is provided for holding syringe 20 in holder recess 26 of bottle 10′. Bottle 10′ is provided with a bottom rest in the form of a base plate 40 formed integrally with bottle 10′ and located at or near the lower end of recess 26, for example, just above the bottom 14 of the bottle. The base plate 40 serves as a support or rest for the end of syringe nozzle 34 when syringe 20 is assembled to bottle 10′ in recess 26 between the opposing arms pair 28. The base plate 40 supplements the tension of retainer arms 28 for supporting the syringe, so that in the second embodiment of FIG. 5 only one pair of retainer arms 28 is provided. A dimple or hole 42 may be provided on base plate 40 for the purpose of receiving the end of syringe nozzle 34 to keep the lower end of the syringe from sliding sideways on the base plate 40.

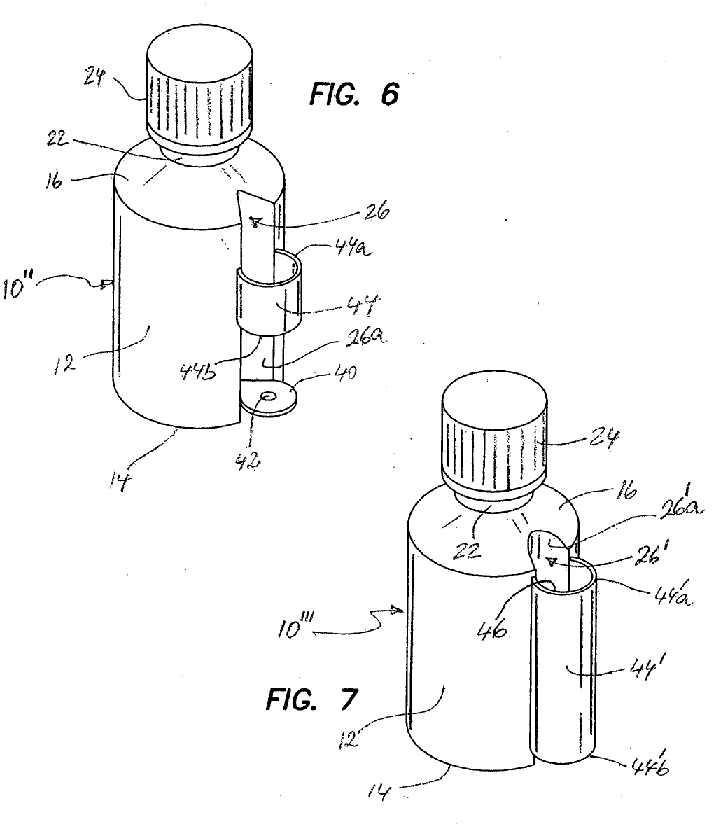

Turning now to FIG. 6, a third embodiment of the medication bottle 10″ is similar to the embodiment of FIG. 5 but the single pair of opposing retainer arms 28 has been replaced by an arcuate, approximately semi-cylindrical retainer sleeve 44 axially aligned with the vertical dimension of the bottle. Holder recess 26 and retainer sleeve 44 together define a tubular syringe holder open at opposite top and bottom ends. Retainer sleeve 44 spans the recess 26 so as to completely encompass the barrel 32 of syringe 20 when the syringe is inserted through the open upper end of this syringe holder and is set with nozzle 34 onto base plate 40. The syringe barrel 32 cross section is partially received in recess 26 as earlier described in connection with FIGS. 1-4 and the remainder of the syringe barrel cross section outside of recess 26 is encompassed by sleeve 44 to securely hold the syringe in recess 26 in assembled relationship to bottle 10″. The syringe is readily lifted from the just described syringe holder when needed for dispensing oral medication from bottle 10″.

FIG. 7 shows a fourth embodiment of the oral medication bottle according to this invention wherein bottle 10′″ differs from previously described embodiments in that holder recess 26′ has an internal partially cylindrical surface 26′a shaped to conform against the outside cylindrical surface of the syringe barrel 32, and also in that sleeve 44′ is axially extended with an upper end near the bottle shoulder 16 and a lower end near bottle bottom 14. The top edge 46 of sleeve 44′ serves as rest for finger flanges 38 of syringe 20 thereby to support the syringe relative to the bottle with the syringe nozzle 34 above and away from contact with an underlying surface supporting the bottle 10′″. For this reason, in the embodiment of FIG. 7 the base plate 40 may be eliminated from bottle 10′″.

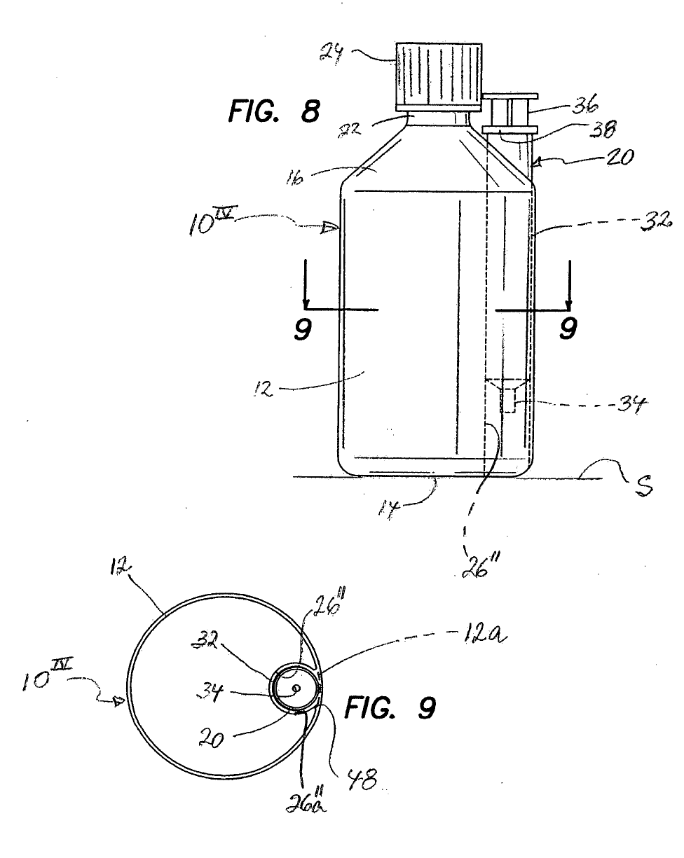

FIGS. 8 and 9 illustrate a fifth embodiment of the invention wherein bottle 10^{iv} has a holder recess 26″ with an inner cylindrically curved surface 26″a parallel to the bottle axis and contained within the circular perimeter of the bottle suggested by the dotted line 12a. Holder recess 26″ thus defines a nearly cylindrical tube which extends vertically through the bottle with a top opening on the bottom shoulder 16 and bottom opening on the bottle bottom 14 and is fully included within the circular perimeter of the bottle wall 12. That is, the imaginary complete circumference of the interior surface of recess 26″ is fully contained within and tangential to the imaginary completed circumference 12a of the cylindrical bottle wall 12. As seen in FIGS. 8 and 9, the syringe 20 is fully contained within the outside circular perimeter of the cylindrical bottle wall and results in a very compact and easy-to-handle bottle-syringe assembly. The finger flanges 28 rest upon the bottle shoulder 16 to support the syringe 20 within holder recess 26″ with syringe nozzle 34 above bottle bottom 14, again to avoid potentially unsanitary contact with a surface S underlying the bottle 10^{iv}.

It is seen in FIG. 9 that the interior surface of recess 26″ encompasses more than 180 degrees and approximately 270 degrees of the syringe barrel circumference, leaving a vertical opening or gap 48 of about 90 degrees of arc and extending the height of the bottle wall 12 but which is too small to pass the diameter of the syringe barrel. In effect, this fifth embodiment may be viewed as integrating the holder recess and the syringe retainer into a form where the portions of the bottle wall 12 adjacent the gap 48 function as retainer arms to contain syringe 20 in recess 26″.

The invention is not restricted to cylindrical bottles and bottles of other shapes, such as rectangular bottles, may be provided with integrally formed syringe holder, recesses and retainers according to this invention.

While preferred embodiments of the invention have been described and illustrated for purposes of clarity and example, it must be understood that many changes, modifications and substitutions will be apparent to those possessed of ordinary skill in the art without thereby departing from the scope of the following claims.

What is claimed is:

1. In combination, a bottle and an oral syringe, said syringe having a syringe barrel with a plunger slidable in one end of said barrel for displacing fluid through an orificed syringe nozzle on an opposite end of said barrel;
said bottle having a bottle wall defining a bottle shoulder and a bottle bottom, and a syringe holder integral with said bottle wall for releasably retaining said syringe in assembled condition to said bottle.

2. The combination of claim 1 wherein said syringe holder includes a holder recess in said bottle wall shaped for at least partially receiving a cross section of said syringe in said holder recess in said assembled condition.

3. The combination of claim 1 wherein said syringe is held in generally parallel relationship to a vertical axis of said bottle with the syringe plunger extending upwardly and said syringe barrel pointing down relative to said bottle.

4. The combination of claim 1 further comprising a bottom plate integral with said bottle wall for supporting an end of said syringe against downward movement through said syringe holder.

5. The combination of claim 1 wherein said syringe holder comprises opposing retainer arms integrally formed with said bottle wall for capturing therebetween said syringe barrel.

6. The combination of claim 1 wherein said syringe holder comprises a retainer sleeve integrally formed with said bottle wall for encompassing said syringe barrel.

7. The combination of claim 2 wherein said syringe holder comprises a retainer sleeve integrally formed with said bottle wall and spanning said holder recess for fully encompassing said syringe barrel and containing a cross section of said syringe partly in said recess and partly in said sleeve.

8. The combination of claim 2 wherein said syringe barrel has outwardly extending finger flanges near one end thereof and said syringe holder includes a rest for supporting said finger flanges thereby to support said syringe relative to said bottle.

9. The combination of claim 5 wherein said opposing retainer arms comprise one pair of said opposing retainer arms.

10. The combination of claim 5 wherein said opposing retainer arms comprise two pairs of said opposing retainer arms.

11. The combination of claim 2 wherein said holder recess has an interior surface cylindrically curved to conform to an outer surface of said syringe barrel.

12. The combination of claim 2 wherein said holder recess is shaped to at least partially circumferentially encompass said syringe barrel.

13. The combination of claim 2 wherein said holder recess is shaped to encompass more than 180 degrees of circumference of said syringe barrel.

14. The combination of claim 2 wherein said holder recess extends from said bottle shoulder to said bottle bottom.

15. The combination of claim 2 wherein said holder recess has a circularly curved interior surface extending from a bottle shoulder to a bottle bottom of said bottle.

16. The combination of claim 2 wherein said holder recess is defined by a pair of flat surfaces intersecting at a corner line extending between a bottle shoulder and a bottle bottom.

17. The combination of claim 2 wherein said bottle wall is a circular bottle wall circumferentially interrupted by said holder recess.

18. The combination of claim 2 wherein said holder recess encompasses more than 180 degrees of a circumference of said syringe thereby to retain said syringe in said holder recess.

19. The combination of claim 18 wherein said holder recess is a substantially tubular holder recess contained within a wall perimeter of said bottle wall.

20. The combination of claim 19 wherein said wall perimeter is a circle defined by a radius of said bottle wall.

21. The combination of claim 19 wherein said tubular holder recess has open top and bottom ends at a shoulder and a bottom of said bottle respectively.

22. In combination, a bottle and an oral syringe of the type having a syringe barrel with a plunger slidable in one end of said barrel for displacing fluid through an orificed syringe nozzle on an opposite end of said barrel;
said bottle having a bottle wall defining a bottle mouth, a bottle shoulder and a bottle bottom, a holder recess in said bottle wall between said shoulder and said bottom shaped for at least partially receiving a cross section of said syringe;
and a syringe retainer integral with said bottle wall for releasably retaining said syringe in said holder recess, wherein said holder recess either
i) has a circularly curved interior surface and extends from a bottle shoulder to a bottle bottom of said bottle; or
ii) is defined by a pair of flat surfaces intersecting at a corner line extending between a bottle shoulder and a bottle bottom; and
said syringe retainer either
iii) comprises opposing retainer arms integrally formed with said bottle wall for capturing therebetween said syringe; or
iv) comprises a retainer sleeve integrally formed with said bottle wall and spanning said holder recess for fully encompassing said syringe cylinder.

23. The combination of claim 22 further comprising a base plate integral with bottle wall for supporting an orificed nozzle of said syringe nozzle away from contact with a surface underlying said bottle.

24. The combination of claim 22 wherein said syringe cylinder has outwardly extending finger flanges and said retainer sleeve has a top edge for supporting said finger flanges thereby to support said syringe relative to said bottle and said syringe nozzle away from contact with a surface underlying said bottle.
